(19) United States
(12) Patent Application Publication
(10) Pub. No.: US 2003/0131882 A1
(43) Pub. Date: Jul. 17, 2003

(54) Pressure balancing valve

(76) Inventor: Lawrence A. Kolze, Seneca, SC (US)

Correspondence Address: Lawrence A. Kolze, 1602 Keowee Lakeshore Drive, Seneca, SC, 29672, US

(21) Appl. No.: 10/045,760

(22) Filed: Jan. 15, 2002

(51) Int. Cl. G05D 11/00

(52) U.S. Cl. 137/98

(57) ABSTRACT

An improved structural arrangement of a pressure balancing valve of the type where flow between two unequal pressure flowing fluids introduced at the valve inlets is regulated to produce substantially equal pressure flowing fluids at its outlets.

The valve assembly incorporates a reciprocating spool member having fluid regulating members at its opposite ends, a pressure sensing member such as a diaphragm or piston member centrally connected to the spool to sense outlet differential pressures of the two fluids and thereby actuate the spool in reciprocating directions whereby said fluid flows are varied by the regulating members to substantially balance the pressure between the two flowing fluids. The structural arrangement permits the balance of pressure forces acting axially across the spool without the need of pressure bleed passages and their possible fluid blockage and also offers advantages of improved corrosion resistance, potential valve size and cost reduction, and high reliability.

### BACKGROUND OF INVENTION

This invention relates to valves given the term balancing valves whose functional purpose is to provide a pressure balance between two flowing fluids. These valves have been commercially available for many years and are of many structural embodiments, but all basically operate on the concept first illustrated in a spool valve configuration of U.S. Pat. No. 962,111 by Carl Assmann in 1910 for a Regulating Apparatus for Mixing Valves.

Patent '111 shows all the basic elements commonly used in these valves, i.e., a sensing means to detect the regulated discharge pressure of the two input fluids, a regulating means responding to the sensor means to equalize the discharge pressure of the two fluids, and a pressure balance force means across the regulating means wherein the pressure balance force means are associated with pressure balance passages.

U.S. Pat. No. 4,241,749 by S. G. Petursson for Pressure Compensating Valves reveals several prior art valve improvements incorporating sliding “O” rings seals, a diaphragm sensing means, and poppet valve regulating means. These improvements undoubtedly have provided more contamination resistant and lower cost valves over the more close fitting precision sliding fit sealing methods indicated in patent '111. The Petursson Patent also illustrates an additional improvement designed to prevent blockage of the pressure balance passages and thereby help assure proper balancing and operation of the regulating means. Although the embodiments of prior art and the improvement illustrated in the Petursson Patent provide satisfactory functional operation, these valves still have the disadvantage of their regulating balance means requiring relatively long, small diameter pressure passages. These pressure passages whether used in the FIG. 1, of the '111, prior art illustration, or the improvement shown in the Petursson Patent still add a degree of extra cost and complexity.

The prior art illustrated balancing valves also have deficiencies in their ability to utilize more corrosion resistant plastic materials in their spool construction. In addition, a costly thread fastening method of spool assembly is employed and an alternative more cost effective assembly would be desirable. These valves also locate their spool pressure balance chamber at each end of their spools and thereby add an objectionable extra dimension to the overall valve assembly. Although extensive past developmental efforts have been made in these valves, the further improvements of the present invention overcome the still existing deficiencies noted.

Accordingly, an object of the present invention is to provide a spool type balancing valve which (1) eliminates small diameter pressure bleed passages which may be subject to fluid blockage, (2) utilizes a fluid regulating assembly permitting greater usage of more corrosion resistant plastic materials, (3) permits a more compact overall construction, and (4) provides a more cost effective means of assembly. The balancing valve devised in this present invention has in general achieved these objectives and is described more fully in the Summary of the Invention below.

### SUMMARY OF INVENTION

In my invention, elimination of pressure bleed passages has been accomplished by location of the spool pressure force balance means centrally on the spool rather than at the outer spool ends and thereby allows exposure of the spool ends directly to the equal discharge flow pressure instead of through the bleed passaged used in prior art. Also, the central placement of the spool pressure force balance means directs the inlet flow against the seat side of the flow regulating units which in some cases overcomes the tendency of pressure chatter conditions which may be encountered when the fluid flow moves in the same direction of closure of the flow regulating means. The central location of the spool pressure force balance means also provides an advantage for a more compact overall valve assembly.

In one aspect, the present invention is a fluid pressure balancing valve comprising: a valve housing having a pair of fluid inlet chambers having respective fluid outlets, said fluid outlets in communication with said respective inlets, and said outlets to discharge said first and second fluids, a spool member within said housing; a pressure sensing member substantially centrally connected in axial relationship to the said spool member and positioned within said housing to separate said outlet chambers, said pressure sensing member responsive to pressure differential between said outlet chamber fluids to actuate said spool member and said flow regulating means in a reciprocating action to control flow from each respective inlet chamber to thereby regulate the passage of said fluids between said inlets and outlets in a pressure balanced manner; and my invention includes the improvement comprising the means whereby the closure direction of said regulating means opposes the direction of said first and second fluids whereby said fluids produce balance forces across said spool and regulating means to permit a greater accuracy of said sensing means and thereby minimize the differential pressure between said first and second fluids discharged at said outlets.

Eliminating the need of the pressure passages that are required by the prior art permits the present invention flow regulating means to be more effectively constructed of corrosion resistant plastics and provides a more cost effective means of the overall spool assembly. Prior art valves with their spool pressure passages are somewhat limited in these respects as the pressure passages occupy the space which could be used for assembly fasteners or for improved component strength. In these balancing valves, a high stress can be created at the small diameter stem section of the spool when the sensing diaphragm by its high force output seats the spool poppet. Since the prior art valves contain pressure passages in the spools, the referenced high stress condition is further aggravated by loss of material taken by the bleed passages. An option of the prior art valves could be to increase the outside diameter of the spool stem to lower the stress, but this would undesirably reduce this section flow passage. In order for these valves to provide a satisfactory size package for the stress and flow requirements, a metal material for the spool stem and regulating means must be opted in their construction. A plastic material would be a preferred lower cost material for these parts, but the stress section area does not permit the use of these lower strength materials. The fabrication of the metal parts is a relatively slow process and therefore costly, as is the associated need of their threaded assembly for fastening to the sensing means. Although the metal used in these valves is considered corrosion resistant, unwanted deposits such as carbonate minerals tend to form more readily on metal material than on plastics and therefore make metals a less preferred choice.

To overcome the above described prior art deficiencies, the present invention, on the other hand, has utilized the space needed by the prior art bleed passages for a spool of composite construction having an outer jacket of corrosion resistant plastic and an inner metal core to obtain a size to strength advantage and a more cost effective riveting assembly means. Although the present invention eliminates the pressure bleed passages, the spool pressure force balance as well as the other basic elements needed with balancing valves are still fully incorporated and thereby do not compromise, in any way, the present invention performance.

Thus, objectives of the present invention have been met in improvement over prior art by: devising a balancing valve construction without small diameter, long length pressure bleed passages; a spool and regulating means of corrosion resistant plastic having an advantageous strength to size construction; a cost effective spool, regulating, and sensing means assembly; and a centrally located spool and regulating pressure means to obtain additional overall valve size advantages.

The constructional features and advantages of the present invention as summarized will become even more apparent upon the reading and reference to the additional detail and description as given herein.

### DESCRIPTION OF DRAWINGS

FIG. 1 is a cross-sectional view of the preferred embodiment of the present invention showing the valve housing, spool and inlet and outlet passages.

FIG. 2 is a portion of the FIG. 1 cross-section illustrating an alternative to the FIG. 1 diaphragm.

### DESCRIPTION OF A PREFERRED EMBODIMENT

Referring now to the drawings, the invention will be described in more detail.

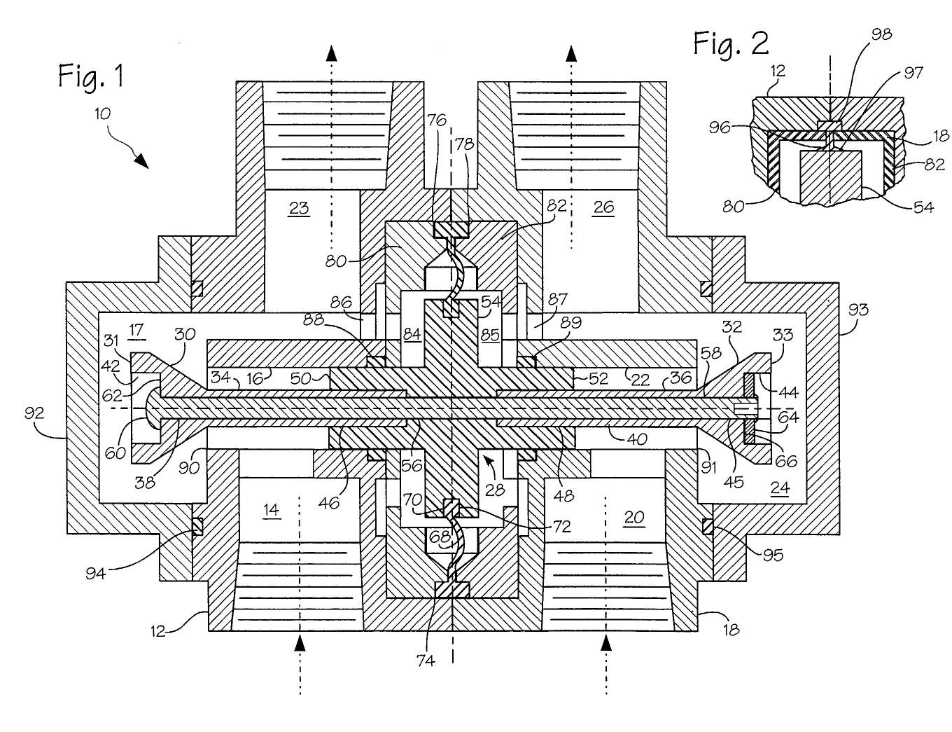

Referring to FIG. 1, the preferred embodiment of the invention assembly is generally indicated at 10 with a first housing 12 having a first fluid inlet 14, a fluid passage bore 16, and a chamber 17, all communicating with a discharge passage 23; a second housing 18 having a second fluid inlet 20, a fluid passage bore 22, and a chamber 24 all communicating with a discharge passage 26. A spool assembly indicated at 28 and within Assembly 10 comprises poppets 30 and 32 which are formed with respective connecting members 34 and 36 having bores 38 and 40 therethrough and axially connect with counter bores 42 and 44 formed in the non-seating sides of poppets 30 and 32. Poppets 30 and 32 with their respective connecting members 34 and 36 are received within respective counter bores 46 and 48 of respective bosses 50 and 52 which are axially positioned on opposite sides of disk member 54 having a bore 56 therethrough and coaxial with counterbores 46 and 48. A corrosion resistant rivet 58 is received within bores 38, 40, and 56 where rivet head 60 butts to the bottom surface 62 of counter bore 42 and its opposite end fitted with a rivet retaining washer 64 abutting bottom surface 66 of counter bore 44 to permit a rivet fastening of disk 54 with bosses 50, 52, poppet 30, its connecting member 34, poppet 32, and its connecting member 36, to form shuttle assembly 28. An elastomeric diaphragm 68 having an inner bead 70 is engaged into a peripheral groove 72 of the disk member 54 to provide an inner seal between diaphragm 68 and disk 54. An outer peripheral seal 74 of diaphragm 68 is clamped between grooves 76 and 78 in respective members 80 and 82 to form chambers 84 and 85 and to provide a seal therebetween as well as a fluid seal between members 12 and 18 which are suitably fastened together to form Assembly 10. Chamber 84 and 85 also communicate through respective passages 86 and 87 to discharge passages 23 and 26 to permit diaphragm 68 to sense fluid pressure differentials between discharge pressures of the first and second fluids. Assembly 10 having bores 16 and 22 slideably receive respective bosses 50 and 52 which are sealed thereabout by seal rings 88 and 89 to prevent fluid flow from inlet passages 14 and 20 into chambers 84 and 85. Bores 16 and 22 terminate into an open end opposite seal rings 88 and 89 to form seating surfaces 90 and 91 for contact with poppets 30 and 32 of spool assembly 28. End caps 92 and 93 are suitably fastened to housing 12 and 18 and sealed with seal rings 94 and 95 to complete the assembly.

Referring again to FIG. 1, operation of a preferred embodiment of the balancing valve is as follows:

When two fluids of unequal pressures are introduced at inlet passages 14 and 20, one of the inlet fluids flow from passage 14, through bore 16, across poppet 30, to chamber 17 and to discharge passage 23; and the other inlet fluid flows from passage 20, through bore 22, across poppet 32, to chamber 24 and to discharge passage 26. As inlet fluids flow across poppets 30 and 32, a pressure drop across each poppet occurs, its magnitude depending upon the fluid flow and position each poppet may be from the seating surface 90 or 91. The fluid pressure in chamber 17 and discharge passage 23 is communicated through passage 86 to chamber 84, and thereby creates a pressure force on the diaphragm 68. Also, the fluid pressure in chamber 24 and discharge passage 26 is communicated through passage 87, to chamber 85 and thereby also creates a pressure force on the opposite side of the diaphragm 68. When the discharge pressures communicated to chambers 84 and 85 are unequal, they create forces on the diaphragm 68 to cause it to displace the spool assembly 28 and poppets 30 and 32 in a direction of whichever discharge passage 23 or discharge passage 26 is of a lower pressure. The spool assembly 28 then moves to more fully open the poppet of the lower pressure side tending to equalize the pressure difference across diaphragm 68. Poppets 30 and 32 repeatedly adjust their opening and closure positions until a final stable equalization of pressure forces across the diaphragm 68 occurs.

In order to achieve a high degree of equalization of the discharge pressures at outlets 23 and 26, it is very important that only the output forces of diaphragm 68 can act upon shuttle assembly 28 to allow poppets 30 and 32 to reach their proper equal pressure regulating positions. If additional forces not related to discharge pressures act upon the shuttle 28, poppets 30 and 32 will move to regulating positions where a greater differential pressure between discharge passages 23 and 26 will occur according to the magnitude of these added forces. It is thus important in pressure balancing valves that forces to the regulating poppets be limited to the output forces from the diaphragm 68 only in order to achieve the greatest sensitivity of diaphragm differential pressures and the most satisfactory results of pressure equalization between discharge passages 23 and 26.

The present invention has achieved the above by providing minimal unbalance pressure forces acting on the shuttle and its poppets by arrangement of the poppet locations and their balance areas and is explained as follows:

When the two inlet fluids of unequal pressures are introduced at inlets 14 and 20, these fluids cause pressure forces to act upon the inlet fluid pressure surface area of bosses 50 and 52 and the effective projected pressure areas of poppets 30 and 32. The pressure forces of the respective poppets and boss members are absorbed within the spool assembly 28 by respective connecting members 34 and 36 and since the respective boss and poppets are designed for their pressure areas to be equivalent, these respective poppet and boss pressure forces are in balance and therefore any unbalanced forces due to inlet pressure forces to act on spool assembly 28 are minimal or do not occur. Also since a pressure equalization between passages 23 and 26 and chambers 17 and 24 are also of equal pressure as previously explained, and since these pressures are acting upon the equal end areas of poppets 30 and 32, pressure forces across the ends of shuttle assembly 28 by these pressures are also equalized. Therefore, the present invention without the need of small pressure passages, provides a means whereby only the diaphragm 68 fluid pressure forces act on the shuttle to position the poppets for regulating outlet discharge pressure in a near optimum manner.

Looking now at FIG. 2, an alternate embodiment to diaphragm 68 is shown wherein flexible seal 96 and 97 are clamped between modified member 80 and 82 to provide a sliding seal for disk member 54 modified as a sliding piston for the discharge pressure sensing means. A separate seal ring 98 provides a fluid seal between members 12 and 18. Use of the FIG. 2 embodiment does not affect the basic operation of the balancing valve as described for the FIG. 1 embodiment, but offers various material selection options for the pressure sensing means in cases where a fluid medium may detrimentally affect an elastomeric diaphragm.

The present invention thus allows pressure balancing valves a unique construction in the elimination of small diameter pressure bleed passages and thereby provides improved resistance to foreign particle blockage as well as satisfying other objectives as previously set forth herein.

Although my invention has been described with respect to the illustrated embodiments, modifications and variations my invention will be apparent to those having ordinary skill in the art after having read and understood the foregoing. Therefore, my invention is limited only by the following claims.

I claim:

1. A fluid pressure balancing valve comprising:
a) a valve housing having a pair of fluid inlet chambers having respective fluid inlets to receive a first and second fluid therein;
b) a pair of fluid outlet chambers having respective fluid outlets, said fluid outlets being in communication with said respective inlets, said outlets to discharge said first and second fluids;
c) regulating means for controlling the flow of said first and second fluids;
d) a spool member within said housing in axial sliding relation therein, said spool member associated with said regulating means for regulating said first and second fluids, said spool member having a central section separating said inlet chambers;
e) a pressure sensing member substantially centrally connected in axial relationship to the said spool member and positioned within said housing to separate said outlet chambers, said pressure sensing member being responsive to pressure differentials between said outlet chamber fluids to actuate said spool member and said flow regulating means in a reciprocating action to control flow from each respective inlet chamber thereby regulating the passage of said fluids between said inlets and outlets in a pressure balanced manner; and,
f) the improvement comprising a pressure force balance means where the closure direction of said regulating means opposes said first and second fluid flow directions to balance the fluid pressure forces between said spool and said regulating means whereby said spool and said regulating forces do not substantially affect said differential pressure sensing means.

2. The valve of claim 1 wherein said pressure force balance means is provided between central section of said spool member and said regulating means.

3. The valve of claim 1 wherein said spool and said regulating means forms an assembly without spool pressure passages.

4. The valve of claim 1 wherein said pressure sensing means is a diaphragm.

5. The valve of claim 1 wherein said regulating means comprises poppet valves positioned at opposite ends of said spool.

6. In a fluid pressure balancing valve comprising:
a) a valve housing having a pair of fluid inlet chambers having respective fluid inlets to receive a first and second fluid herein;
b) a pair of fluid outlet chambers having respective fluid outlets, said fluid outlets for discharging said first and second fluids.
c) A spool member within said housing in axial sliding relation; said spool member being associated with a regulating means; said regulating means and said spool member formed of plastic materials and fastened into a spool and regulating means assembly by metallic fastening means.
d) A pressure sensing member substantially centrally connected in axial relationship to the said spool member and positioned within said pressure sensing member responsive to pressure differentials between said outlet chamber fluids to actuate said spool member and said flow regulating means in reciprocating action to control flow from each respective inlet chamber and regulate the passage of said fluids, between said inlets and outlets in pressure balanced manner;

7. The valve of claim 6 wherein said metallic fastening means extends axilly through the said spool and regulating means assembly.

8. The valve claim 6 wherein said pressure sensing member is a sliding piston type member.

9. A fluid pressure balancing valve comprising:
a) a valve housing having a pair of fluid inlet chambers with respective fluid inlets to receive a first and second fluid therein, a pair of fluid outlet chambers having respective inlets and outlets to receive and discharge said first and second fluids;
b) means for regulating the flow of said first and second fluids;
c) a spool member positioned within said housing in axial sliding relation therein said spool member being associated with regulating means for regulating said first and second fluids, said spool member separating said inlet chambers; and
d) a pressure sensing member substantially centrally connected in axial relationship to the said spool member and responsive to pressure differential between said outlet chamber fluids to actuate said spool member and said flow regulating means in a reciprocating action to control flow from each respective inlet chamber to thereby regulate the passage of said fluids between said inlets and outlets in a pressure balanced manner; and,
e) a central section associated with said spool member for providing a pressure force balance with said regulating means whereby said pressure sensing means is substantially unaffected by fluid pressure forces acting upon said spool member and said regulating means and thereby permit said sensing means to position said regulating means by pressure differentials provided only between said outlet chamber fluids, without the need of small pressure balancing passages.

10. The valve of claim 9 wherein said pressure sensing member is a sliding piston type member.
